(19) United States
(12) Patent Application Publication
(10) Pub. No.: US 2016/0098927 A1
(43) Pub. Date: Apr. 7, 2016

(54) ELECTRONIC VEHICLE IDENTIFICATION SYSTEM

(71) Applicant: Ferrari ANAEL, Santa Cruz do Sul (BR)

(72) Inventor: Ferrari ANAEL, Santa Cruz do Sul (BR)

(21) Appl. No.: 14/967,321

(22) Filed: Dec. 13, 2015

Related U.S. Application Data
(63) Continuation of application No. PCT/BR2014/000251, filed on Jul. 21, 2014.

(30) Foreign Application Priority Data
Jul. 31, 2013 (BR) 1020130194387

(51) Int. Cl. G08G 1/137

(52) U.S. Cl. CPC G08G 1/137

(57) ABSTRACT

An electronic vehicle identification system comprises a processing unit (1) having identification information of a vehicle that receives and processes signals from a two-way communication module (2) that simultaneously sends information of said vehicle, detects, and receives identification information of other vehicles that are within the range of the detection module, wherein said processing unit (1) is also associated with a GPS module (3) and a memory (4) that contains a map database that is updated via the internet or other conventional means, wherein said processing unit (1) is also connected to a non-volatile memory (5) whereon it stores date, time, and location of the vehicle itself and equivalent information of the rest of the vehicles situated within the range of the detection module (2), and also a user interface (6) whereon it displays information and receives commands from said user.

The present invention relates to an electronic device having a specific number (ID) for identifying vehicles instead of the traditional system of metal license plates attached to both the front and rear of a vehicle.

Currently, vehicles are identified and individualized by metal license plates attached to both the front and rear of vehicles containing an alphanumeric sequence that identifies the vehicle and is related to the registration thereof with the competent authority.

In view of this, the main purpose of the present invention is to characterize a new concept for vehicle identification, making metal license plates currently in use obsolete and dispensable.

### BRIEF DESCRIPTION OF THE DRAWINGS

The following drawings are merely exemplary of the preferred embodiments of the concept proposed herein without intending to limit the protection only to these particular examples, in which:

FIG. 1 is a block diagram of the system illustrating its component parts.

FIG. 2 is a schematic drawing of a LCD screen that may serve as an interface between the processor and the user.

FIG. 3 is a perspective drawing of a possible GPS module that may be used in the invention.

FIG. 4 shows a RF (radiofrequency) module that may be used by the invention.

FIG. 5 shows a GSM module that may be used by the invention.

FIG. 6 shows a non-volatile semiconductor Flash memory suitable for the invention.

### DETAILED DESCRIPTION OF THE INVENTION

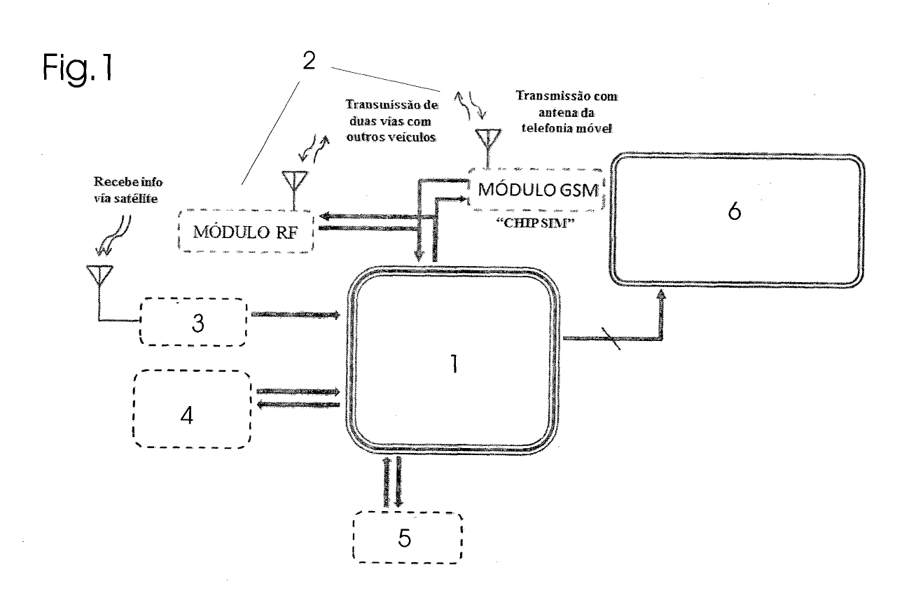

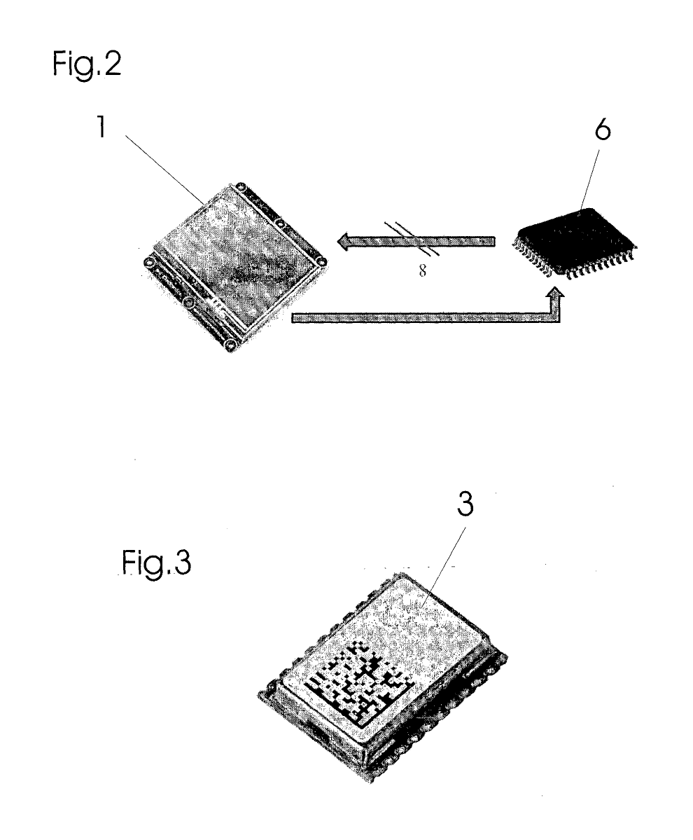

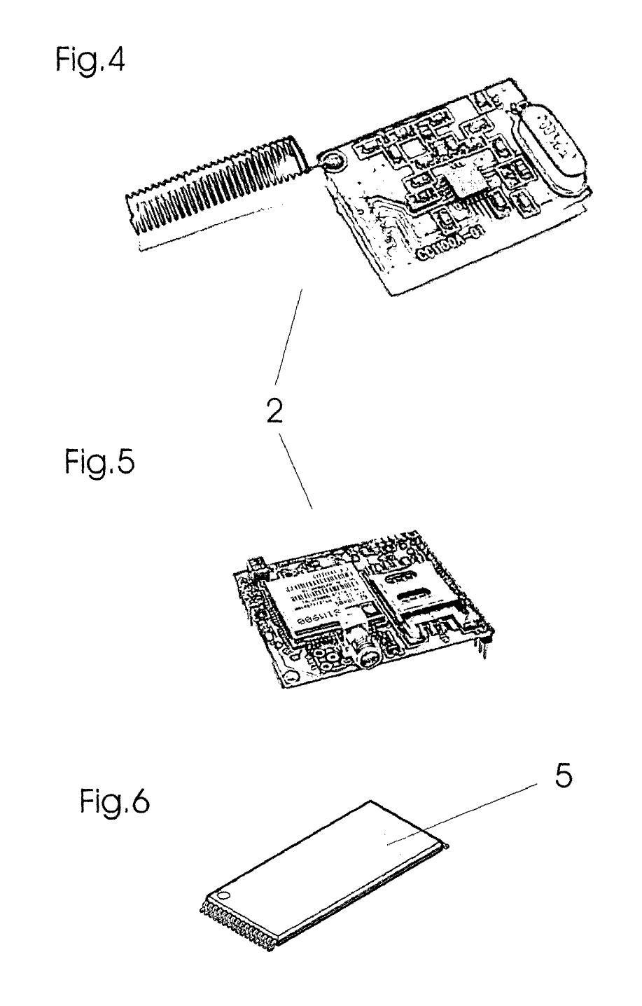

Referring to FIG. 1, there is shown an electronic vehicle identification system comprising a processing unit (1) having vehicle identification information that receives and processes signals from a two-way communication module (2) that simultaneously sends its information, detects, and receives identification information of other vehicles that are within the range of the detection module (2), said processing unit also being associated with a GPS module (3) that sends geographic coordinates of a vehicle position, as well as a memory (4) that contains the map database to locate said vehicle. The processing unit (1) is also connected to a non-volatile Flash memory (5) that stores such data as date, time, and location of the vehicle itself and equivalent information of the rest of the vehicles situated within the range of the detection module (2), and also to an interface with the user (6) on which it displays information and receives commands from said user.

In a preferred embodiment, the circuit and the instruments of a vehicle are powered through a parallel electric connection such that said vehicle has to be running to make its identification information available for access by other vehicles. Thus, the present invention allows for the engraving of a discreet identification number onto the vehicle windshield for verification and identification when the vehicle is turned off.

In a preferred embodiment of the present invention, the processing unit (1) is composed of a microcontroller that controls all the processes inside the system, both managing the data received from the GPS system (3) and accessing the database (4) the contains the maps thereof, determining how said maps will be displayed on the user interface (6). The microcontroller (1) is also responsible for processing the identification information of the vehicles that are within the range of the detection module (2), storing the identification information of said vehicles, places, dates and time when said information is obtained in the non-volatile memory (5), thus providing important data in case of traffic accidents and also making this information available on the user interface (6) on request.

In this embodiment, all the modules that make up the system are connected to the processing unit (1) through serial communication with the microcontroller. In spite of using the same type of communication (serial), different devices use different protocols to send information, considering different levels of security due to the importance of data and quantity of information that each device needs to send to the processor (1).

Preferably, the user interface (6) comprises a liquid crystal display (LCD) screen. Said LCD screen (6) displays all data that arrive at the processor (1) and also allows the user to interact with what is displayed. A model that may be used for this purpose, which is suitable but not exclusive, is a color 320×240 LCD TFT display having a 5.7″ resistive touchscreen. Said touchscreen receives the data for display through an 8-bit protocol and is able to show not only the current position of the vehicle driven but also that of other vehicles that are within the range of the detection module (2). Considering the road data supplied by the GPS, these vehicles will be identified on the screen (6) by a geometric shape. Occasionally, the vehicle driven may be identified in a different manner, by a geographic shape of a different color, by adding a fill to it or in another color, thus enabling the user to view its position as well as the identification details of any detected vehicle only by touching the shape that defines the desired vehicle on the screen. The ID number will be supplied, implanted in a safe and inviolable manner and controlled by a traffic management authority such that if the ID has been violated or modified, the geometric shape identifying the vehicle will appear in a different manner showing other drivers, traffic guards, and police control posts that is in an “irregular” situation (e.g., different color or shape, a flashing geometric shape or a shape of a different size). Examples of such “irregular” situations that would bring about such indications on the screen are auto theft records in the computerized system of the traffic management authority, search and seize orders or unpaid taxes or fees. The police control posts may have stationary or mobile identification systems such as those that would be installed on vehicles in general, enabling them, due to the connectivity that such police control posts have with the database of the traffic management authority, to identify a vehicle(s) with unpaid taxes or an unlicensed/irregular vehicle(s) that approach(es) and is (are) within the range of the detection mode.

A data bus allows communication between the processor (1) and the LCD screen (6) in order to send all images to be viewed to the LCD screen (6) and a connection with the data from the touchscreen (6) which will inform the processor (1) a point where the user touched the screen and also inform the public data of the selected vehicle in a horizontal line at the bottom of the display, said data remaining displayed and replaced by the other data only when, again, the user touches other vehicle(s) detected while en route or moving. There will be provided forward and back navigation buttons, preferably, in the bottom left portion of the display (6) at the beginning of the horizontal line, allowing the user to view the vehicle data that he has requested and that are stored in the memory by touching such buttons.

The GPS module (3) used to supply geographic position of vehicles is preferably attached to a printed circuit board and electrically interconnected to the processor (1). The GPS receiving module (3) receives electromagnetic signals from at least four satellites orbiting the Earth. The time difference between the signals from each satellite allows the module (3) to calculate the exact geographic position of a vehicle in addition to calculating the speed at which it is travelling and the time of that geographic position. A GPS module (3) suitable for that purpose may have an accuracy of 2.5 meters and an update rate of 2 seconds and is powered by 3.3 volts. Such characteristics as accuracy and update rate are of vital importance for the viability of the product since vehicles will be surely always on the move. As already shown above, said module (3) must have a serial communication port to send and receive data from the processor (1).

In a preferred embodiment, the two-way communication module (2) responsible for the data traffic between the vehicles having a device according to the present invention is a radiofrequency (RF) module. Said module (2) in conjunction with the microcontroller (1) is responsible for codification when the vehicle sends its data on the allocated radio band as well as for codification when the very same module receives information from other vehicles. A suitable (but not exclusive) device that may be used for this purpose is 433 MHz RF Transceiver having a CC1101 chip from Texas Instruments that allows sending and receiving information serially at a distance of up to 100 m. Said module (2) is powered by 3.3V.

In another embodiment, the vehicle detection and identification module (2) may be obtained by using a SIM card (subscriber identity module) used in conjunction with mobile technology, which is a chip, that can store data, used in this case with a number which is a vehicle identification number and which cannot be changed. In use, a module (2) (shown in FIG. 5) that reads the data stored on the SIM card and processes all actions that are necessary to establish the communication between the antennas of the mobile network operators of which the SIM card is part.

The GSM module (2) comprises frequencies in 4 different bands, popularly called Quad-Band (850/900/1800/1900 MHz), providing a possibility of connectivity with any mobile network operator depending on the vehicle owner's choice. It also allows sending SMS messages in addition to having small physical dimensions (24 mm×24 mm×3 mm).

The process is basically the same as the one that uses the RF module, using however a mobile network operator for the identification information traffic between the users. The police control posts may have stationary or mobile identification systems such as those that would be installed on vehicles in general, enabling them, due to the connectivity that such police control posts have with the database of the traffic management authority, to identify a vehicle(s) with unpaid taxes or an unlicensed/irregular vehicle(s) that approach(es) and is (are) within the range of the detection mode.

The non-volatile memory is preferably a non-volatile semiconductor Flash memory. The memories have 1,000,000 read/write cycles, that is, the process of recording the information and later reading the recorded information. As said memory is non-volatile, the information will not be lost when energy or power is withdrawn. Said memory (5) will be configured to store such data as location and time of the vehicle itself as well as identification information of other vehicles that may come within the range of the detection module (2). The writing process will be that of a circular queue, that is, after the free space of the memory is full, the first information will be overwritten such that new information is stored at the place of the older information.

The GPS map memory contains data stored and organized in a file. The present invention also includes the step of updating these files via the internet.

It will be obvious to a person skilled in the art that numerous modifications, additions and replacements may be made without deviating from the scope of the invention as claimed below.

1. An Electronic Vehicle Identification System comprising a processing unit (1) having identification information of a vehicle that receives and processes signals from a two-way communication module (2) and simultaneously sends information of said vehicle, detects, and receives identification information of other vehicles that are within its range in the detection mode, the processing unit (1) is associated with a GPS module (3) and a memory (4) that contains a map database to locate said vehicle wherein said processing unit (1) is connected to a non-volatile memory (5) that stores such data as date, time and location of the vehicle itself and equivalent information of the rest of the vehicles situated within the range of the detection module (2); and further comprising a user interface (6) whereon it displays information and receives commands from said user.

2. The Electronic Vehicle Identification System of claim 01 wherein the processing unit (1) consists of a microcontroller.

3. The Electronic Vehicle Identification System of claim 01 wherein the user interface (6) consists of a liquid crystal display (LCD) screen.

4. The Electronic Vehicle Identification System of claims 01 wherein, in addition to the current position of the vehicle driven, said screen shows the position of all other vehicles that are within the detection range of the detection module (2).

5. The Electronic Vehicle Identification System of claim 01 wherein the vehicles are identified on the screen (6) by a geometric shape and the vehicle driven is identified in a different manner.

6. The Electronic Vehicle Identification System of claims 01 wherein the geometric shape identifying the vehicle is shown in a different manner in case the ID stored in the processing unit (1) has been violated or modified or is in an irregular situation.

7. The Electronic Vehicle Identification System of claim 01 wherein the GPS module (3) also calculates the speed at which said vehicle is travelling, date and time at said geographic position.

8. The Electronic Vehicle Identification System of claim 01 wherein the vehicle detection and identification module (2) is a radiofrequency (RF) module.

9. The Electronic Vehicle Identification System of claim 01 wherein the vehicle detection and identification module (2) is a GSM module (2) used in conjunction with a SIM card whereon the vehicle identification is stored.

10. The Electronic Vehicle Identification System of claims 01 wherein the GSM module operates on frequencies in 4 different bands (850/900/1800/1900 MHz) and also allows sending SMS messages.

11. The Electronic Vehicle Identification System of claim 01 wherein the non-volatile memory (5) is a non-volatile semiconductor Flash memory with the writing process in a circular queue.
